(19) United States
(12) Patent Application Publication
(10) Pub. No.: US 2023/0264249 A1
(43) Pub. Date: Aug. 24, 2023

(54) ALLOY PLATE MATERIAL SUPPLYING DEVICE AND CAN FORMING DEVICE

(71) Applicant: ALTEMIRA Co., Ltd., Tokyo (JP)

(72) Inventor: Katsunori ABE, Bunkyo-ku, Tokyo (JP)

(73) Assignee: ALTEMIRA Co., Ltd., Tokyo (JP)

(21) Appl. No.: 18/019,797

(22) PCT Filed: Aug. 17, 2021
(86) PCT No.: PCT/JP2021/029998

§ 371 Date: Feb. 4, 2023

(30) Foreign Application Priority Data
Sep. 10, 2020 (JP) 2020-152268

(51) Int. Cl. B21D 51/26

(52) U.S. Cl. CPC B21D 51/2692; B21D 51/26

(57) ABSTRACT

A lubricator 2 supplies an unwound coil material as an alloy plate material 11 to a metal beverage can production line for forming the alloy plate material 11 into a metal beverage can. The lubricator 2 includes: a felt roll 21 configured to contain lubricating oil in a first outer circumferential section, a felt roll 22 with a second outer circumferential section, a plate material lift configured to switch between a first state in which the alloy plate material 11 contacts the first outer circumferential section of the felt roll 21 and the second outer circumferential section of the felt roll 22, and the first outer circumferential section and/or the second outer circumferential section apply the lubricating oil to the alloy plate material 11, and a second state in which the felt roll 21 and/or the felt roll 22 applying the lubricating oil in the first state are idly rotatable by separating from the alloy plate material 11, and an air receiving section configured to apply a driving force to the idly rotatable felt roll 21 and/or the idly rotatable felt roll 22 in the second state as switched by the plate material lift.

### TECHNICAL FIELD

The present invention relates to an alloy plate material supplying device for supplying an alloy plate material to a can forming device for forming a metal beverage can, and the can forming device.

### BACKGROUND ART

Patent Literature 1 discloses a configuration in which oil is applied to the surface of a plate material by controlling, for control of an oil application amount, a metering pump that supplies the oil to the surface of at least one of a pair of rollers with a variable rotary driving device to adjust an application thickness of the oil applied to the surface of the plate material according to a desired speed of the plate material, when a desired oil is applied to the surface of the plate material by running the plate material of a desired thickness between the pair of upper and lower rollers.

Patent Literature 2 discloses a scraper conveyor in which a number of scrapers are swingably attached via a cantilever arm to an endless chain that circulates and moves through upper and lower two-stages guide rails provided between both ends of a conveyance gutter, and the direction of each scraper is reversed by sliding the cantilever arm against the scraper guide provided at both ends of the conveyance gutter. The scraper conveyor is provided with a roller that contacts the cantilever arm of the scraper in a non-conveyance state that moves the upper guide rail and an oil pot that replenishes the roller with lubricating oil.

### CITATION LIST

### Patent Literature

### Patent Literature 1: Japanese Patent Application Laid-Open Publication No. 2006-334565

### Patent Literature 2: Japanese Patent Application Laid-Open Publication No. 2007-169031

### SUMMARY OF INVENTION

### Technical Problem

When a pair of rolls is rotating, lubricating oil replenished and stored inside each roll is distributed almost uniformly in a circumferential direction on an outer circumferential surface of the rolls, so that the lubricating oil is applied uniformly to the alloy plate material that is passed between the pair of rolls.

However, when a rotation of the rolls is stopped, the lubricating oil accumulates on a lower side of each roll, and as time passes, uniform distribution is not maintained in the circumferential direction of the outer circumferential surface of the rolls.

If a process of forming a blank material into a cup-shaped material stops, the alloy plate material stops running and the rolls that apply the lubricating oil also stop. Therefore, if the lubricating oil is not applied uniformly to the alloy plate material and uneven application occurs at the initial stage of restarting the process after a long period of stoppage, the cup-shaped material formed in the portion with uneven application may be discarded in terms of product quality, and cause a deterioration of yield.

It is an object of the present invention to provide an alloy plate material supplying device and a can forming device that can suppress uneven application of lubricating oil to an alloy plate material after restarting.

### Solution to Problem

An alloy plate material supplying device according to an aspect of the present invention is the alloy plate material supplying device for supplying an unwound coil material as an alloy plate material to a can forming device for forming the alloy plate material into a metal beverage can, the alloy plate material supplying device includes: a first roll configured to contain lubricating oil in a first outer circumferential section; a second roll with a second outer circumferential section; a switching unit configured to switch between a first state in which the alloy plate material contacts the first outer circumferential section of the first roll and the second outer circumferential section of the second roll, and the first outer circumferential section and/or the second outer circumferential section apply the lubricating oil to the alloy plate material, and a second state in which the first roll and/or the second roll applying the lubricating oil in the first state are idly rotatable by separating from the alloy plate material; and a driving force applying unit configured to apply a driving force to the idly rotatable first roll and/or the idly rotatable second roll in the second state as switched by the switching unit.

Here, the driving force applying unit may apply a rotational driving force to the idly rotatable first roll and/or the idly rotatable second roll to alternate a period of applying a driving force and a period of not applying a driving force. Further, the driving force applying unit may include: a controlling section configured to control ejection of compressed air; and a portion of the first roll and/or the second roll which receive the ejected compressed air. Moreover, the switching section switches the first state to the second state by moving one of the first roll and the second roll away from the other, and moving the alloy plate material away from the other.

Further, from another standpoint, a can forming device according to an aspect of the present invention is the can forming device for forming an alloy plate material with an unwound coil material into a metal can, the can forming device includes: a first roll configured to contain lubricating oil in a first outer circumferential section; a second roll with a second outer circumferential section; a switching unit configured to switch between a first state in which the alloy plate material contacts the first outer circumferential section of the first roll and the second outer circumferential section of the second roll, and the first outer circumferential section and/or the second outer circumferential section apply the lubricating oil to the alloy plate material, and a second state in which the first roll and/or the second roll applying the lubricating oil in the first state are idly rotatable by separating from the alloy plate material; and a driving force applying unit configured to apply a driving force to the idly rotatable first roll and/or the idly rotatable second roll in the second state as switched by the switching unit.

### Advantageous Effects of Invention

The present invention can suppress uneven application of lubricating oil to an alloy plate material after restarting.

### BRIEF DESCRIPTION OF DRAWINGS

FIG. 1 is a simplified diagram to illustrate an example of application of lubricating oil in a metal beverage can production line.

FIG. 2 is a schematic diagram to illustrate the metal beverage can production line.

FIG. 3 illustrates a configuration example of a lubricator.

FIGS. 4A, 4B and 4C illustrate a distribution of lubricant in a felt roll, and FIG. 4A illustrates the distribution during operation, FIG. 4B illustrates the distribution during idling or idle rotation, and FIG. 4C illustrates the distribution during a long period of stoppage as a comparative example.

FIGS. 5A, 5B and 5C illustrate an idling mechanism, and FIG. 5A is a plan view of one end of the felt roll, FIG. 5B is a side view of one end of the felt roll, and FIG. 5C is a cross-sectional view taken along the line C-C in FIG. 5B.

### DESCRIPTION OF EMBODIMENTS

Embodiments of the present invention will be described below with reference to attached drawings.

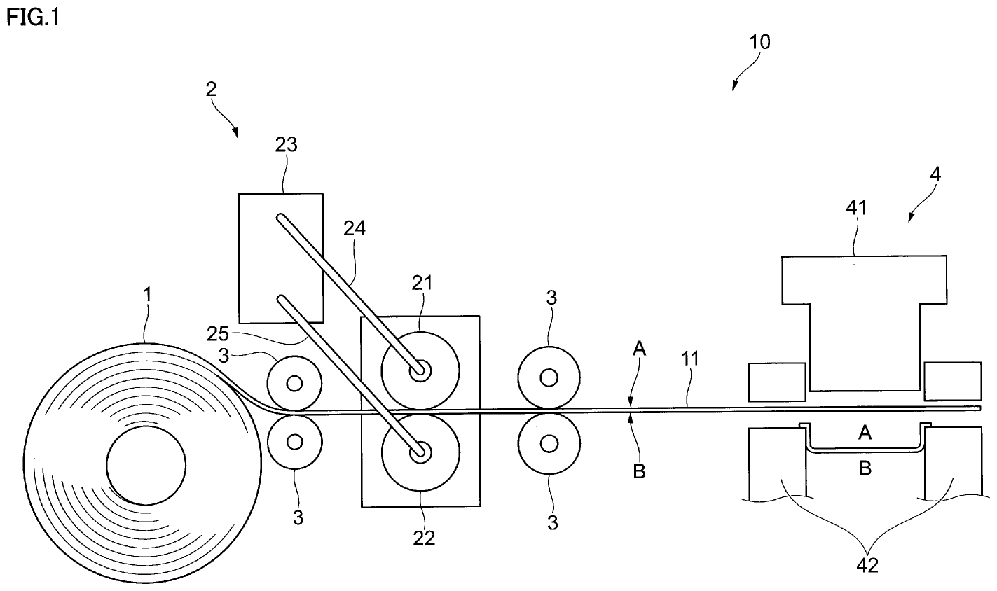

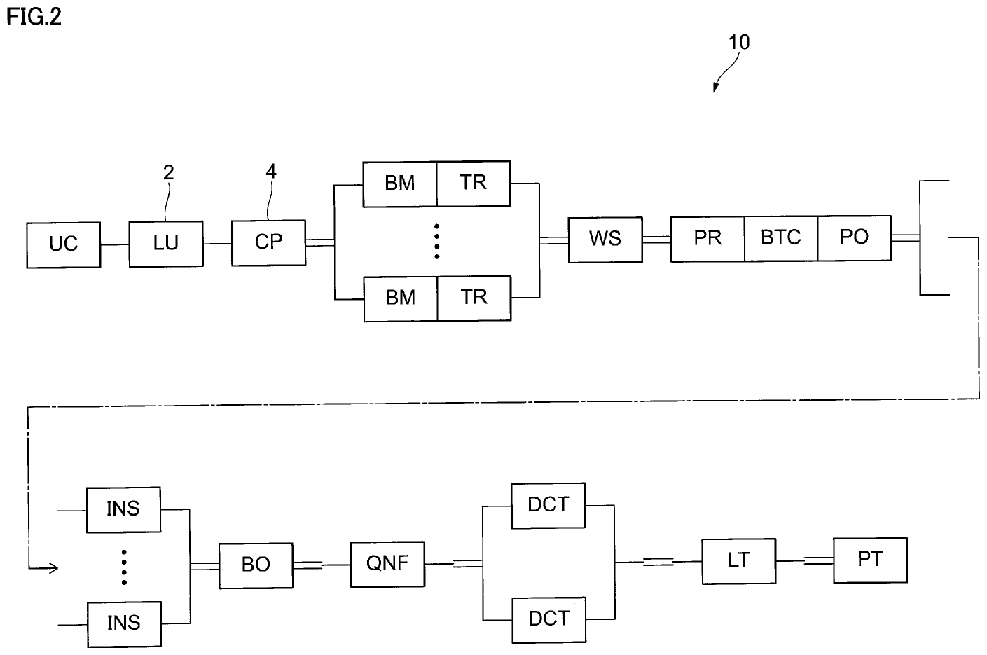

FIG. 1 is a simplified diagram to illustrate an example of application of lubricating oil in a metal beverage can production line 10 and FIG. 2 is a schematic diagram to illustrate the metal beverage can production line 10.

A metal beverage can, especially an aluminum alloy beverage can, is formed from an alloy plate material 11 and is usually manufactured through the same processes as conventional ones, which will be described in detail below.

The beverage can referred to herein is particularly preferably a closed-end cylindrical can, and the material thereof is preferably aluminum or aluminum alloy, and particularly preferably 3004 alloy and 3104 alloy, which are widely used for metal can bodies. The beverage can body is formed by drawing and ironing, and the contents are preferably alcoholic beverages such as beer or Chuhai (shochu-based beverages), or soft drinks (non-alcoholic beverages).

As shown in FIG. 1, the metal beverage can production line 10 includes a lubricator (LU) 2 and a cupping press (CP) 4. The metal beverage can production line 10 also includes an uncoiler (UC) shown in FIG. 2 for unwinding a coil material 1.

The alloy plate material 11 shown in FIG. 1 employs the coil material 1 wound in a coil shape. The coil material 1 has first lubricating oil applied to both sides of the alloy plate material 11 in advance to prevent scratching during transportation.

The state in which the first lubricating oil is applied to both sides of the alloy plate material 11 includes the state in which the first lubricating oil is applied to one side of the alloy plate material 11 and the alloy plate material 11 is wound in the coil shape, resulting in the first lubricating oil being adhered to both sides of the alloy plate material 11.

The coil material 1 is unwound by the uncoiler (UC) to provide the alloy plate material 11, which is sent downstream by a feed roll 3 while being sandwiched between felt rolls 21 and 22 provided on both upper and lower sides of the alloy plate material 11.

The cupping press 4 is provided downstream of the uncoiler (UC). The cupping press 4 punches out a circular blank material from the alloy plate material 11, and performs the drawing such that a punch 41 is pressed into a die 42 to form a cup-shaped material.

In order to prevent appearance defects such as chipping, scratches, wrinkles and pinching (abnormal elongation) from occurring on a surface of the cup-shaped material formed by the drawing, a process of applying lubricant to a surface of the alloy plate material 11 by the lubricator (LU) 2 is provided in the preceding process of the drawing process.

When the cup-shaped material is formed, the cup-shaped material is sent to a body maker (BM) that performs the drawing and ironing on the cup-shaped material to form a can body with a side wall of predetermined thickness and a bottom. Furthermore, an upper ear portion of a circumferential wall of the can body is trimmed to form the closed-end cylindrical can body.

The can body is cleaned by a washing device (WS), and then provided with printing on an outer circumferential side surface of the can body by a printer (PR), painted on an outer surface of a can bottom by a bottom coater (BTC), and baked by a pin oven (PO).

The can body with the printed outer surface is painted on an inner surface by an inside spray (INS), and the painted inner surface is baked and dried in a bake oven (BO).

Thereafter, an opening edge of the can body is necked and flanged with a necker flanger (QNF), or in the case of a screw-lid can, the opening edge is necked, and then threaded to form into a final shape of the can body.

The can body formed into the final shape is inspected for appearance by a defective can tester (DCT) and for holes by a light tester (LT). The can judged to be good in each inspection is loaded on a pallet by a palletizer (PT) and shipped as a product.

A process with a long takt time on the production line is processed in parallel by dividing the same process into multiple parts to shorten the cycle time of the entire production line, from forming the can body from the coil material 1 to loading it on the pallet.

### <First Lubricating Oil and Second Lubricating Oil>

Since the outer surface of the can is subjected to more severe processing in the drawing and ironing process than the inner surface, it is necessary to keep a thicker oil film thickness. A high viscosity of the lubricating oil generally enables the oil film thickness to be kept thick to satisfy the required lubrication performance, so that it is preferable that a viscosity of the second lubricating oil is higher than a viscosity of the first lubricating oil. However, this is not limiting and any other conditions may be used as long as the oil film thickness on the surface of the cup-shaped material is sufficiently kept.

The lubricating oil such as re-oil as the first lubricating oil and the lubricant as the second lubricating oil are applied to form the oil film on the surface of the alloy plate material 11. The lubricant is applied only in the preceding process of the drawing process, while a small amount of the re-oil is applied to the coil material 1 in advance.

In the drawing and ironing process, coolant, which is the lubricating oil for maintaining lubricity during forming and for cooling the alloy plate material 11, is applied.

The coolant applied in the drawing and ironing process and the small amount of the re-oil applied to the coil material 1 in advance may be the same or may have different viscosity, so that the coolant and the re-oil are not particularly limited.

The lubricant is stored in a tank 23 of the lubricator 2, which is a lubricating machine, and supplied from the tank 23 of the lubricator 2 to the upper felt roll 21 through a supply pipe 24, and is applied to an upper surface A of the alloy plate material 11 (a side that becomes an inner surface A of the can body) through the felt roll 21. The lubricant supplied from the tank 23 to the lower felt roll 22 through a supply pipe 25 is applied to a lower surface B of the alloy plate material 11 (a side that becomes an outer surface B of the can body) through the felt roll 22.

The lubricant is applied to both sides of the alloy plate material 11, but this is not limiting; a configuration example in which the lubricant is applied only to one side of the alloy plate material 11 may be adopted. For example, the lubricant is not applied to the upper surface A of the alloy plate material 11, but is applied only to the lower side B of the alloy plate material 11 through the lower felt roll 22.

### <Configuration Example of the Lubricator 2>

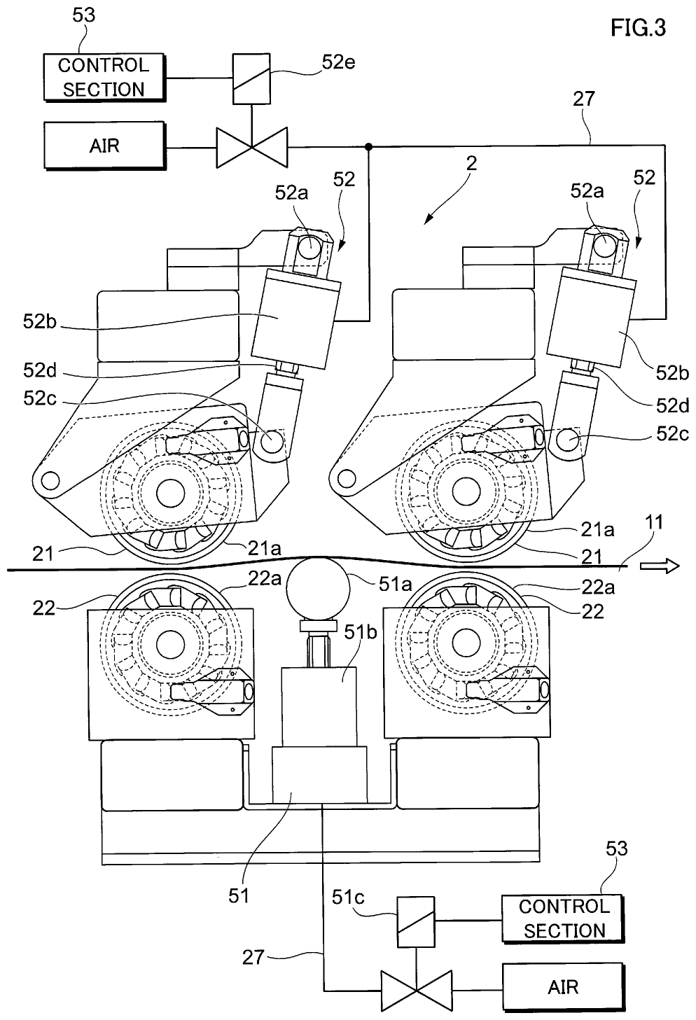

FIG. 3 illustrates a configuration example of the lubricator 2.

The lubricator 2 shown in FIG. 3 includes a plate material lift 51 that lifts the alloy plate material 11, and the felt rolls 21 and 22 are arranged on upstream and downstream in a conveyance direction of the alloy plate material 11 of the plate material lift 51, respectively. The felt rolls 21 and 22 on the upstream and the felt rolls 21 and 22 on the downstream are arranged at different positions in a length direction (perpendicular to a paper surface) of the plate material lift 51 (staggered arrangement). The number of the felt rolls arranged in the length direction of the plate material lift 51 (the number of staggered arrangements) is determined according to the width of the alloy plate material 11.

The plate material lift 51 includes a lifting section 51a that can come into contact with and separate from the alloy plate material 11, and an air cylinder 51b that lifts and lowers the lifting section 51a. An air pipe 27 supplies air (compressed air) to the air cylinder 51b. The lifting section 51a is lifted and lowered by controlling the ON/OFF of a solenoid valve 51c of the air pipe 27. The solenoid valve 51c is controlled for its ON/OFF by a control section 53.

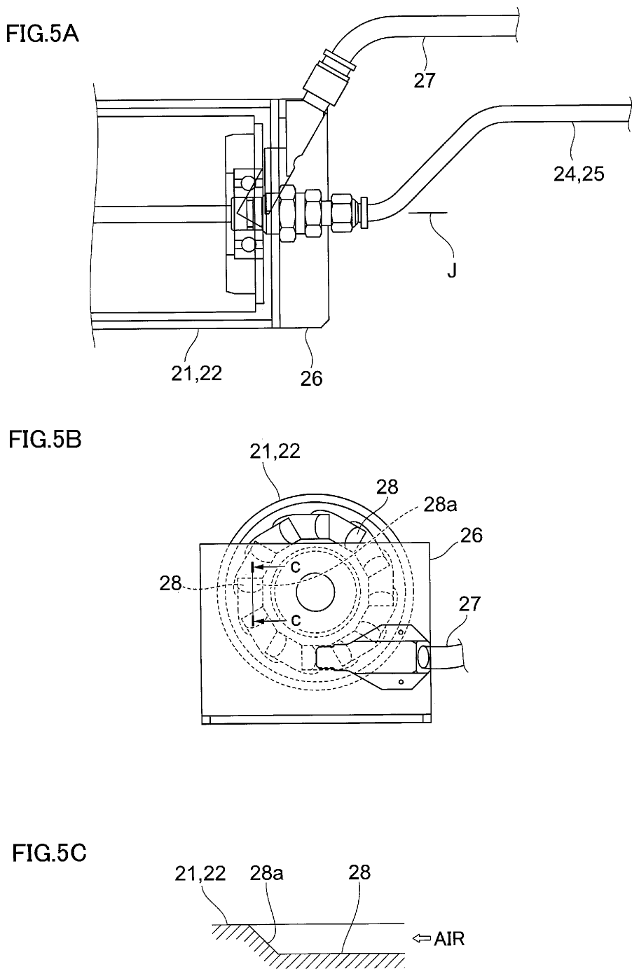

Thus, the plate material lift 51 moves and lifts the alloy plate material 11 in the same direction with the felt roll 21 moved away from the felt roll 22. The alloy plate material 11 and all the felt rolls 21 and 22 are separated, and the felt rolls 21 and 22 are rotated by an idling mechanism (refer to FIG. 5), which will be described later.

The lubricator 2 includes a moving mechanism 52 for moving the upper felt roll 21 in a vertical direction. In the present embodiment, the moving mechanism 52 is an air cylinder as a driving source composed of a cylinder 52b with a fixed side fulcrum 52a and a rod 52d with a moving side fulcrum 52c. The air pipe 27 supplies air to the cylinder 52b of the moving mechanism 52. The upper felt roll 21 is lifted and lowered by controlling the ON/OFF of a solenoid valve 52e of the air pipe 27. The solenoid valve 52e is controlled for its ON/OFF by the control section 53.

The moving mechanism 52 retracts the upper felt roll 21 upward, and thereby the felt roll 21 and the felt roll 22 can be separated from each other.

The present embodiment adopts a configuration in which the lower felt roll 22 does not move up and down unlike the felt roll 21.

The lubricator 2 can be switched between a state in which the alloy plate material 11 is in contact with outer circumferential surfaces 21a and 22a of the felt rolls 21 and 22, and a state in which the alloy plate material 11 is separated from the outer circumferential surfaces 21a and 22a of the felt rolls 21 and 22, by the solenoid valves 51c and 52e of the plate material lift 51 and the moving mechanism 52. The plate material lift 51, the moving mechanism 52, the solenoid valves 51c and 52e and the control section 53 in the present embodiment are examples of a switching unit.

The lubricator 2 described above is an example of an alloy plate material supplying device, and the metal beverage can production line 10 is an example of a can forming device. The lubricant applied to the alloy plate material 11 by the lubricator 2 is an example of lubricating oil. One of the felt rolls 21 and 22 is an example of a first roll and the other is an example of a second roll, and the outer circumferential surface of the one roll is an example of a first outer circumferential section, and the outer circumferential surface of the other roll is an example of a second circumferential section.

### <Distribution of the Lubricant >

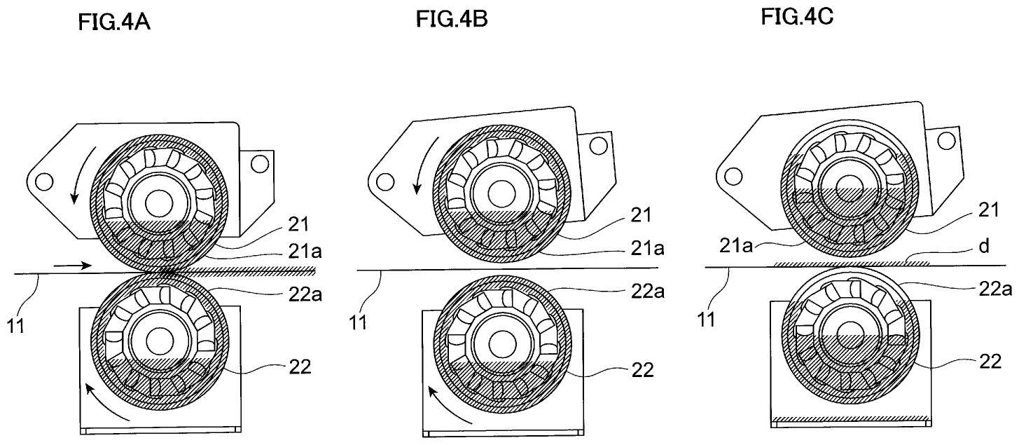

FIGS. 4A, 4B and 4C show a distribution of the lubricant in the felt rolls 21 and 22. FIG. 4A illustrates the distribution during operation, FIG. 4B illustrates the distribution during idling or idle rotation, and FIG. 4C illustrates the distribution during a long period of stoppage as a comparative example. FIGS. 4A, 4B and 4C show a pair of felt rolls 21 and 22 for convenience of explanation.

The felt roll 21 includes the outer circumferential surface 21a containing the lubricant, and the felt roll 22 includes the outer circumferential surface 22a containing the lubricant. During the operation shown in FIG. 4A, the alloy plate material 11 is conveyed by the feed roll 3 (refer to FIG. 1), and the felt rolls 21 and 22 sandwiching the alloy plate material 11 are driven to rotate. Thus, the felt rolls 21 and 22 are in contact with an internal lubricant over the entire circumference of the outer circumferential surface 21a and 22a as the felt rolls 21 and 22 rotate, so that the distribution of the lubricant over the circumferential direction of the outer circumferential surfaces 21a and 22a of the felt rolls 21 and 22 becomes uniform.

As described above, the lubricant is supplied from the tank 23 (refer to FIG. 1) to the felt rolls 21 and 22 during the operation.

Further, during the idling shown in FIG. 4B, the alloy plate material 11 is not moved, while the felt rolls 21 and 22 are rotatable. During the idling, the felt rolls 21 and 22 are separated from each other, and the alloy plate material 11 is also separated from the felt rolls 21 and 22, unlike during the operation shown in FIG. 4A.

It should be noted that the supply of the lubricant is stopped during the idling.

To further explain, the felt rolls 21 and 22 during idling rotate idly rather than being stopped all the time. The idle rotation of the felt rolls 21 and 22 is an operation to make the distribution of the lubricant uniform over the circumferential direction of the outer circumferential surfaces 21a and 22a of the felt rolls 21 and 22. For this reason, the felt rolls 21 and 22 may be rotated constantly or rotated and stopped repeatedly. In other words for the latter case, a rotational driving force is applied to the felt rolls 21 and 22 so that a period of applying the driving force alternates with a period of not applying the driving force. Interposing the period of not applying the driving force can help suppress a power while maintaining uniform distribution of the lubricant, which contributes to energy saving.

The idle rotation of the felt rolls 21 and 22 may be alternately controlled by rotating one of them and not rotating the other, or alternately controlled by rotating one of them, rotating the other, and not rotating either of them. Furthermore, when the felt rolls 21 and 22 are rotated idly, a control example can be considered in which a forward rotation state and a reverse rotation state are repeated.

In FIG. 4C shown as a comparative example, the upper felt roll 21 is lifted by the moving mechanism 52 and is separated from the lower felt roll 22. Also, the alloy plate material 11 is separated from the outer circumferential surface 21a of the upper felt roll 21, but is in contact with the outer circumferential surface 22a of the lower felt roll 22.

The state shown as the comparative example is during a long period of stoppage, in which the conveyance of the alloy plate material 11 is stopped and the rotation of the felt rolls 21 and 22 is also stopped. For this reason, the lubricant in the felt rolls 21 and 22 accumulates on a lower side, and the amount of the lubricant increases in each lower side of the outer circumferential surfaces 21a and 22a, while the amount of the lubricant decreases in an upper side.

Thus, in the comparative example, the uniform distribution of the lubricant in the circumferential direction of the outer circumferential surfaces 21a and 22a of the felt rolls 21 and 22 is not maintained, resulting in non-uniformity. Therefore, at the time of restarting, the lubricant cannot be applied uniformly to the alloy plate material 11, and there is a high possibility that forming defects will occur when the alloy plate material 11 is punched out and subjected to the drawing process by the cupping press 4, and thus the formed cup-shaped material is discarded.

Moreover, the lubricant drips from the outer circumferential surface 21a of the felt roll 21 onto the alloy plate material 11. In FIG. 4C, lubricant d that drips from the lower side of the felt roll 21 onto the alloy plate material 11 is shown. The cup-shaped material formed from such a portion of the alloy plate material 11 is also undesirable in terms of product quality and is discarded.

In the comparative example, the discarding of the cup-shaped material at the time of the restarting cause a deterioration of yield, and furthermore, it is difficult to restart automatically due to the need for operating personnel at the time of the restarting.

As shown in FIG. 4B, during the stoppage, the uniform distribution of the lubricant in the circumferential direction of the outer circumferential surfaces 21a and 22a of the felt rolls 21 and 22 can be maintained and the occurrence of uneven application can be suppressed by idly rotating the felt rolls 21 and 22 with the alloy plate material 11 separated from the outer circumferential surfaces 21a and 22a. Moreover, it is possible to prevent the lubricant from dripping from the felt rolls 21 onto the alloy plate material 11.

Here, in FIGS. 4B and 4C, because the felt rolls 21 and 22 have been operating normally until the lubricator 2 stops, the lubricant is normally applied to the alloy plate material 11 passing through the felt rolls 21 and 22 (refer to the alloy plate material 11 on the exit side of the felt rolls 21 and 22 in FIG. 4A). However, the applied lubricant is not shown in FIGS. 4B and 4C to facilitate understanding.

Even if the lubricant is applied to the alloy plate material 11 only with the lower felt roll 22, the defect of the uneven application of the lubricant to the alloy plate material 11 occurs at the time of the restarting. The same defect occurs in the case of applying the lubricant only with the upper felt roll 21.

### <Idling Mechanism >

FIGS. 5A, 5B and 5C illustrate an idling mechanism, where FIG. 5A is a plan view of one end of the felt rolls 21 and 22, FIG. 5B is a side view of one end of the felt rolls, and FIG. 5C is a cross-sectional view taken along line C-C in FIG. 5B. The configurations shown in FIGS. 5A, 5B and 5C are common to both felt rolls 21 and 22, therefore, these will be described with one drawing.

As shown in FIG. 5A, in the idling mechanism according to the present embodiment, the air pipe 27 for supplying air is provided to a support member 26 for rotationally supporting the ends of the felt rolls 21 and 22, in addition to the supply pipes 24 and 25 described above. The ejection of air supplied by the air pipe 27 is controlled by a solenoid valve. The air is ejected toward end surfaces of the felt rolls 21 and 22 by controlling the ON/OFF of the solenoid valve.

To further explain, as shown in FIG. 5B, the air in the air pipe 27 is ejected in a direction other than a rotation axis J of the felt rolls 21 and 22. Plural air receiving sections 28 are formed at predetermined intervals in the circumferential direction around the rotation axis J on the end surfaces of the felt rolls 21 and 22. The air receiving sections 28 are provided at a position away from the rotation axis J of the felt rolls 21 and 22. In the present embodiment, twelve air receiving sections 28 are provided at 30 degree intervals.

As shown in FIG. 5C, the air receiving sections 28 of the felt rolls 21 and 22 include a recess formed on the end surfaces of the felt rolls 21 and 22 and a receiving surface 28a formed in the recess. The receiving surface 28a is inclined so that a force to rotate the felt rolls 21 and 22 acts when air hits. Therefore, the end surfaces of the felt rolls 21 and 22 act like an impeller, and when air is ejected, the felt rolls 21 and 22 rotate idly.

The felt rolls 21 and 22 are held rotatably, so that the felt rolls 21 and 22 do not stop immediately after the air ejection is stopped, but rotate for a while. Therefore, the felt rolls 21 and 22 can be idly rotated periodically by ejecting air intermittently.

More specifically, the driving force is applied to the felt rolls 21 and 22 by ejecting air, and the driving force is not applied to the felt rolls 21 and 22 upon stoppage of ejecting air. During the period of applying the driving force, the felt rolls 21 and 22 continue to rotate, but it does not mean that the felt rolls 21 and 22 do not rotate during the period of not applying the driving force, but the felt rolls 21 and 22 continue to rotate due to inertia, and the rotation slows down due to friction and other factors, and eventually stops.

Therefore, except during the operation, the felt rolls 21 and 22 rotate periodically by controlling the solenoid valve so that the period of applying the driving force alternates with the period of not applying the driving force, which makes it possible to maintain the uniform distribution of the lubricant in the circumferential direction of the felt rolls 21 and 22.

The air receiving sections 28 and the control section 53 of the felt rolls 21 and 22 are examples of a driving force applying unit.

In the present embodiment, air is used for applying the driving force to the felt rolls 21 and 22. This is a configuration that facilitates piping when modifying a conventional device since the plate material lift 51 and the moving mechanism 52 use air as a driving source as described above.

An electric motor may be used for applying the driving force to the felt rolls 21 and 22, but there are disadvantages that the control becomes more troublesome and the maintenance takes more time and effort than in the case of using air. In the present embodiment, the use of air prevents the complexity of the control and suppresses the reduction in maintenance efficiency compared with the case of using the electric motor.

### REFERENCE SIGNS LIST

2 Lubricator

10 Metal beverage can production line

11 Alloy plate material

21, 22 Felt roll

21a, 22a Outer circumferential surface

28 Air receiving section

51 Plate material lift

51c, 52e Solenoid valve

52 Moving mechanism

53 Control section

1. An alloy plate material supplying device for supplying an unwound coil material as an alloy plate material to a can forming device for forming the alloy plate material into a metal beverage can, the alloy plate material supplying device comprising:
a first roll configured to contain lubricating oil in a first outer circumferential section;
a second roll with a second outer circumferential section;
a switching unit configured to switch between a first state in which the alloy plate material contacts the first outer circumferential section of the first roll and the second outer circumferential section of the second roll, and the first outer circumferential section and/or the second outer circumferential section apply the lubricating oil to the alloy plate material, and a second state in which the first roll and/or the second roll applying the lubricating oil in the first state are idly rotatable by separating from the alloy plate material; and
a driving force applying unit configured to apply a driving force to the idly rotatable first roll and/or the idly rotatable second roll in the second state as switched by the switching unit.

2. The alloy plate material supplying device according to claim 1, wherein
the driving force applying unit applies a rotational driving force to the idly rotatable first roll and/or the idly rotatable second roll to alternate a period of applying a driving force and a period of not applying a driving force.

3. The alloy plate material supplying device according to claim 1, wherein
the driving force applying unit comprises: a controlling section configured to control ejection of compressed air; and a portion of the first roll and/or the second roll which receive the ejected compressed air.

4. The alloy plate material supplying device according to claim 1, wherein
the switching section switches the first state to the second state by moving one of the first roll and the second roll away from the other, and moving the alloy plate material away from the other.

5. A can forming device for forming an alloy plate material with an unwound coil material into a metal can, the can forming device comprising:
a first roll configured to contain lubricating oil in a first outer circumferential section;
a second roll with a second outer circumferential section;
a switching unit configured to switch between a first state in which the alloy plate material contacts the first outer circumferential section of the first roll and the second outer circumferential section of the second roll, and the first outer circumferential section and/or the second outer circumferential section apply the lubricating oil to the alloy plate material, and a second state in which the first roll and/or the second roll applying the lubricating oil in the first state are idly rotatable by separating from the alloy plate material; and
a driving force applying unit configured to apply a driving force to the idly rotatable first roll and/or the idly rotatable second roll in the second state as switched by the switching unit.

6. The alloy plate material supplying device according to claim 2, wherein
the driving force applying unit comprises: a controlling section configured to control ejection of compressed air; and a portion of the first roll and/or the second roll which receive the ejected compressed air.
